(19) United States
(12) Patent Application Publication
(10) Pub. No.: US 2013/0133807 A1
(43) Pub. Date: May 30, 2013

(54) FILM PLASTING DEVICE AND METHOD

(71) Applicants: Haifang Wang, Wujiang (CN); Deo Guo, Wujiang (CN); Ching-Feng Hsieh, Taipei (TW)

(72) Inventors: Haifang Wang, Wujiang (CN); Deo Guo, Wujiang (CN); Ching-Feng Hsieh, Taipei (TW)

(73) Assignees: Askey Computer Corporation, Taipei (TW); Askey Technology (JiangSu) Ltd., Wujiang (CN)

(21) Appl. No.: 13/397,093

(22) Filed: Feb. 15, 2012

(30) Foreign Application Priority Data
Nov. 29, 2011 (TW) 100143666

(51) Int. Cl. B32B 37/00

(52) U.S. Cl. 156/60; 156/538

(57) ABSTRACT

A film pasting device for pasting a protection film on a display screen is provided, which includes: a main body having a receiving slot for receiving the protection film so as for the display screen to be disposed on the protection film; a base disposed in the receiving slot for carrying the protection film and the display screen; a positioning member disposed on the main body for positioning the display screen on the base; and a vertical movement member disposed over the main body and movable towards the base so as to provide a vertical force for pressing the display screen down, thereby pasting the protection film on top and side surfaces of the display screen through the vertical force provided by the vertical movement member and a horizontal force provided by the main body, respectively. Therefore, the present invention improves the film pasting quality and saves operation time.

### BACKGROUND OF THE INVENTION

1. Field of the Invention The present invention relates to film pasting techniques, and, more particularly, to a film pasting device and method for pasting a protection film to a display screen.

2. Description of Related Art

Generally, a waterproof adhesive film is manually pasted on a display screen of a mobile phone. During such a pasting process, the waterproof adhesive film is manually aligned with and pressed onto the display screen. The process is not only time-consuming, but also has the following drawbacks: (1) it is not easy to take the waterproof adhesive film by hand during the pasting process; (2) taking the waterproof adhesive film by hand would easily pollute surfaces of the waterproof adhesive film; (3) the waterproof adhesive film easily bends at sides thereof due to its small thickness; (4) the waterproof adhesive film is likely pasted askew due to its poor strength and is easy to be warped due to uneven manual power when it is pasted to side surfaces of the display screen. Consequently, a re-pasting process is needed. In addition, the manual pasting process adversely affects standardized operations for fabricating mobile phones.

Therefore, there is a need to provide film pasting techniques so as to overcome the above-described drawbacks.

### SUMMARY OF THE INVENTION

In view of the above-described drawbacks, an object of the present invention is to provide a film pasting device and method so as to improve the film pasting quality and save operation time and manual power.

Another object of the present invention is to provide a film pasting device and method so as to achieve standardized operations.

In order to achieve the above and other objects, the present invention provides a film pasting device for pasting a protection film on a display screen, which comprises: a main body having a receiving slot for receiving the protection film so as for the display screen to be disposed on the protection film; a base disposed in the receiving slot for carrying the protection film and the display screen; a positioning member disposed on the main body for positioning the display screen on the base; and a vertical movement member disposed over the main body and movable towards the base so as to provide a vertical force for pressing the display screen down, thereby pasting the protection film on top and side surfaces of the display screen through the vertical force provided by the vertical movement member and a horizontal force provided by the main body, respectively.

In the above-described film pasting device, the base can further comprise a carrier for carrying the protection film and the display screen, and a pneumatic guiding member connected to the carrier for guiding the carrier to move up and down in the receiving slot.

In the above-described film pasting device, the base can further comprise a carrier for carrying the protection film and the display screen, and a spring connected to the carrier for guiding the carrier to move up and down in the receiving slot.

In the above-described film pasting device, the positioning member can have a frame structure and the area enclosed by the inner edges of the frame structure is the same in size as that of the display screen.

In an embodiment, a first positioning unit is disposed on the main body, and a second positioning unit is disposed on the positioning member and engagable with the first positioning unit, so as to position the positioning member on the main body.

The present invention further provides a film pasting method applicable to a main body having a receiving slot and a vertical movement member, which comprises the steps of: (1) disposing a protection film in the receiving slot; (2) positioning a display screen on the protection film; and (3) pressing the display screen down through a vertical force provided by the vertical movement member so as to paste the protection film on top and side surfaces of the display screen through vertical force provided by the vertical movement member and a horizontal force provided by the main body, respectively.

According to the present invention, a protection film can be automatically pasted to top and side surfaces of a display screen so as to save operation time and manual power and effectively improve the film pasting quality.

### BRIEF DESCRIPTION OF DRAWINGS

FIG. 1 is a schematic perspective view of a film pasting device according to the present invention;

FIGS. 2A and 2B are schematic side cross-sectional views of the main body of the film pasting device of FIG. 1;

FIGS. 3A to 3D are schematic views showing a film pasting method using the film pasting device according to the present invention;

FIGS. 4A to 4D are schematic cross-sectional views of FIGS. 3A to 3D, respectively; and

FIG. 5 is a schematic view of a protection film.

### DETAILED DESCRIPTION OF PREFERRED EMBODIMENTS

The following illustrative embodiments are provided to illustrate the disclosure of the present invention, these and other advantages and effects can be apparent to those in the art after reading this specification.

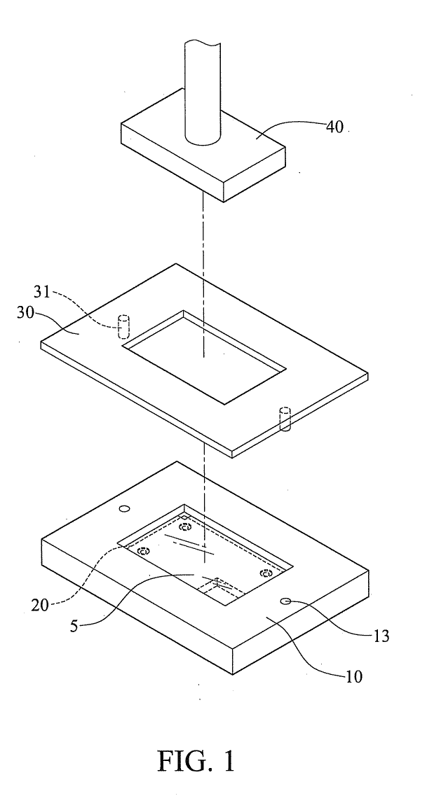

FIG. 1 is a schematic perspective view of a film pasting device according to the present invention. The film pasting device can be used to paste a protection film on a display screen. In the present embodiment, the display screen refers to a display screen of a mobile electronic device, and the protection film refers to a waterproof adhesive film. But it should be noted that the present invention is not limited thereto. In other embodiments, the present invention is applicable to other kinds of display screens and protection films.

Referring to FIG. 1, the film pasting device has a main body 10, a base 20, a positioning member 30, and a vertical movement member 40.

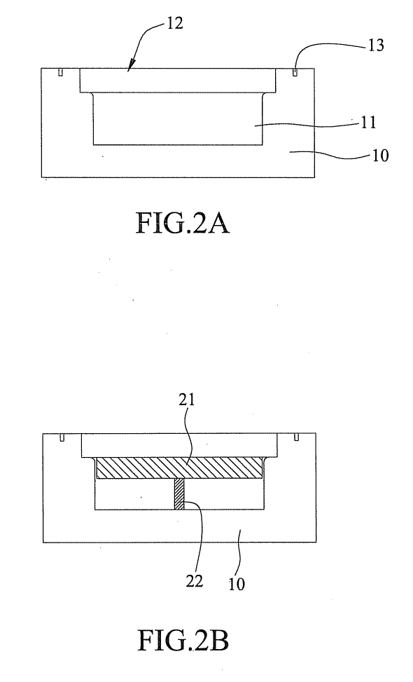

Referring to FIGS. 1 and 2A, the main body 10 is formed with a first receiving slot 11 and a second receiving slot 12 formed over the first receiving slot 11. The first and second receiving slots 11 and 12 can be collectively referred to as a receiving slot. The first receiving slot 11 is used for receiving the base 20 with a protection film 5 disposed thereon. The second receiving slot 12 is used for receiving a display screen so as to allow the display screen to be disposed on the protection film. In the present embodiment, referring to FIG. 2A, the second receiving slot 12 is slightly larger than the first receiving slot 11 such that the first and second receiving slots 11 and 12 constitute a T-shaped receiving slot. But it should be noted that the present invention is not limited thereto. Further, as shown in FIG. 2A, smooth arc-shaped portions are formed between the main body 10, the first receiving slot 11, and the second receiving slot 12, so as to facilitate subsequent movements of the base, the protection film and the display screen in the receiving slot.

Referring to FIGS. 1 and 2B, in an embodiment of the present invention, the base 20 comprises a carrier 21 and a pneumatic guiding member 22 connected to the carrier 21. The base 20 is disposed in the first receiving slot 11 and capable of moving up and down in the first receiving slot 11. The base 20 is used for carrying the protection film and the display screen. In particular, as shown in FIG. 2B, the carrier 21 is used for carrying the protection film and the display screen, and the pneumatic guiding member 22 guides the carrier 21 to move up and down in the first receiving slot 11. But it should be noted that the present embodiment is only for illustrative purposes and is not intended to limit the present invention. Alternatively, the pneumatic guiding member 22 can be a spring (not shown) or any other means having the same effect.

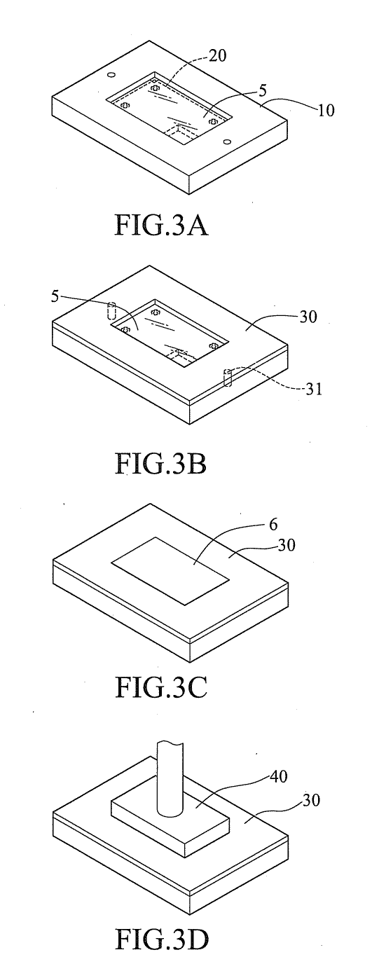

Referring to FIGS. 1 and 3C, the positioning member 30 is used for positioning the display screen on the base 20. In an embodiment, the positioning member 30 has a frame structure. The base 10 has a first positioning unit 13, and the positioning member 30 has a second positioning unit 31 engagable with the first positioning unit 13 so as to position the positioning member 30 on the main body 10, thereby positioning the display screen 6 on the base 20. The first positioning unit 13 can be a positioning recess, and the second positioning unit 31 can be a positioning column Preferably, inner edges of the positioning member 30 enclose a surface area (also called as a third region) that has the same size as the display screen so as to achieve a preferred positioning effect for the display screen.

Referring to FIGS. 1 and 3D, the vertical movement member 40 is disposed over the main body 10. Preferably, the vertical movement member 40 is disposed over the T-shaped receiving slot of the main body 10 and movable towards the base 20 so as to provide a vertical force to press the display screen down into the first receiving slot 11. As such, the protection film is pasted on top and side surfaces of the display screen through the vertical force provided by the vertical movement member 40 and a horizontal force provided by the main body 10, respectively.

The present invention further provides a film pasting method. First, a protection film is provided in the receiving slot. Then, a display screen is disposed on the protection film. Further, the vertical movement member is used to provide a vertical force so as to press the display screen down, thereby pasting the protection film to top and side surfaces of the display screen through vertical and horizontal forces provided by the vertical movement member and the main body, respectively.

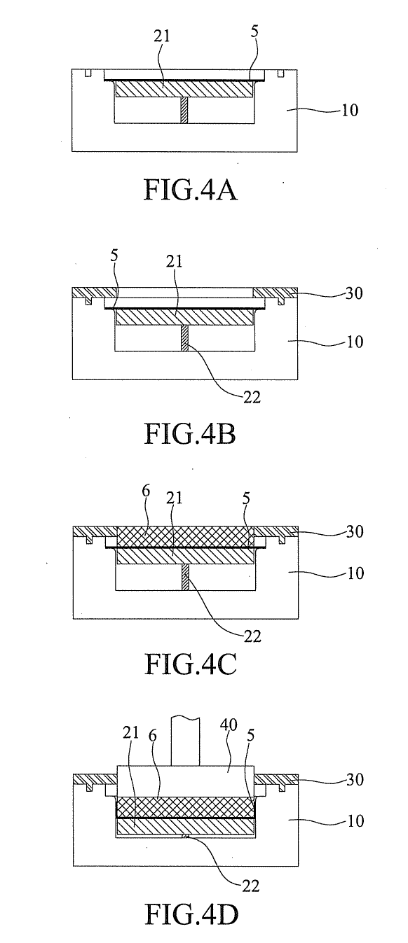

FIGS. 3A to 3D and FIGS. 4A to 4D are schematic views showing detailed steps of a film pasting method using the film pasting device according to the present invention. FIGS. 4A to 4D are schematic cross-sectional views of FIGS. 3A to 3D, respectively.

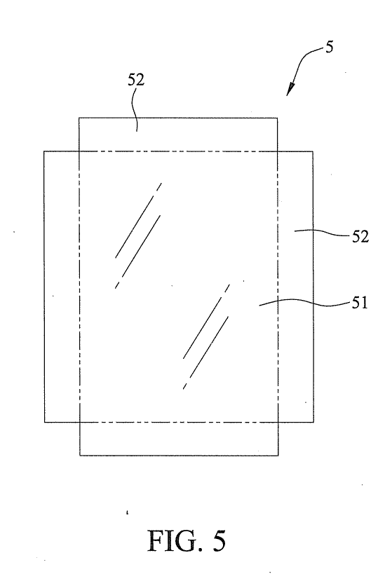

Referring to FIG. 1, the film pasting device having the main body, the base, the positioning member and the vertical movement member is provided. Then, referring to FIGS. 3A and 4A, a protection film 5 is disposed in the second receiving slot 12 of the main body 10. The protection film 5 is made of a transparent material, for example, and is defined with a first region 51 and a second region 52 at peripheries of the first region 51 (as shown in FIG. 5). The first region 51 has a surface area slightly less than that of the first receiving slot 11 such that portions of the protection film 5 of the second region are bent up to thereby allow the protection film 5 to be pasted on top and side surfaces of the display screen 6 in a subsequent film pasting process.

Referring to FIGS. 3B and 4B, the positioning member 30 is positioned on the main body 10. In the present embodiment, the second positioning unit 31 of the positioning member 30 engages with the first positioning unit 13 of the main body 10 so as to position the positioning member 30 on the main body 10. In an embodiment, the positioning member 30 is a frame structure and an area enclosed by inner edges of he frame structure is the same in size as that of the display screen 6.

Referring to FIGS. 3C and 4C, the display screen 6 is upside-down disposed inside the positioning member 30 so as to be positioned on the carrier 21 of the base 20, thereby preventing displacement of the display screen during the subsequent film pasting process. Side edges of the display screen 6 cover portions of the protection film 5 between the first and second regions. The first positioning unit 13 and the second positioning unit 31 can be a positioning recess and a positioning column, respectively. The pneumatic guiding member 22 or any other means having the same effect is connected to the carrier 21 for guiding the carrier 21 to move up and down in the first receiving slot 11.

Referring to FIGS. 3D and 4D, the vertical movement member 40 (as shown in FIG. 1) provides a vertical force to press the display screen 6 down such that portions of the protection film 5 between the first and second regions are pasted to the side edges of the display screen 6. Since the gap between the display screen 6 and the first receiving slot 11 matches with the protection film 5 in thickness, when the vertical movement member 40 further presses the display screen 6 down into the first receiving slot 11, portions of the protection film 5 uncovered by the display screen 6 are bent up towards the side surfaces of the display screen 6 so as to be securely pasted to the side surfaces of the display screen 6.

Compared with the conventional manual operation, the present invention can automatically paste a protection film on top and side surfaces of a display screen so as to improve the film pasting quality, save operation time and manual power and achieve standardized operations.

The above-described descriptions of the detailed embodiments are only to illustrate the preferred implementation according to the present invention, and it is not to limit the scope of the present invention. Accordingly, all modifications and variations completed by those with ordinary skill in the art should fall within the scope of present invention defined by the appended claims.

What is claimed is:

1. A film pasting device for pasting a protection film on a display screen, comprising:
a main body having a receiving slot for receiving the protection film so as for the display screen to be disposed on the protection film;
a base disposed in the receiving slot for carrying the protection film and the display screen;
a positioning member disposed on the main body for positioning the display screen on the base; and
a vertical movement member disposed over the main body and movable towards the base so as to provide a vertical force for pressing the display screen down, thereby pasting the protection film on top and side surfaces of the display screen through the vertical force provided by the vertical movement member and a horizontal force provided by the main body, respectively.

2. The film pasting device of claim 1, wherein the base further comprises a carrier for carrying the protection film and the display screen, and a pneumatic guiding member connected to the carrier for guiding the carrier to move up and down in the receiving slot.

3. The film pasting device of claim 1, wherein the base further comprises a carrier for carrying the protection film and the display screen, and a spring connected to the carrier for guiding the carrier to move up and down in the receiving slot.

4. The film pasting device of claim 1, wherein the positioning member is a frame structure and an area enclosed by inner edges of the frame structrure is the same in size as that of the display screen.

5. The film pasting device of claim 1, further comprising a first positioning unit disposed on the main body, and a second positioning unit disposed on the positioning member and engagable with the first positioning unit so as to position the positioning member on the main body.

6. The film pasting device of claim 1, wherein the main body has a T-shaped receiving slot, and the vertical movement member is located over the T-shaped receiving slot of the main body.

7. A film pasting method applicable to a main body having a receiving slot and a vertical movement member, comprising the steps of:
(1) disposing a protection film in the receiving slot;
(2) positioning a display screen on the protection film; and
(3) pressing the display screen down through a vertical force provided by the vertical movement member so as to paste the protection film on top and side surfaces of the display screen through the vertical force provided by the vertical movement member and a horizontal force provided by the main body, respectively.

8. The film pasting method of claim 7, wherein the protection film is defined with a first region and a second region, allowing the first region of the protection film to have a surface area less than that of the receiving slot.

9. The film pasting method of claim 8, wherein at step (3), side edges of the display screen are pressed to cover portions of the protection film between the first and second regions.

10. The film pasting method of claim 9, wherein at step (3), the horizontal force bends and presses uncovered portions of the protection film towards the side surfaces of the display screen.
